(19) United States
(12) Patent Application Publication
(10) Pub. No.: US 2013/0300196 A1
(43) Pub. Date: Nov. 14, 2013

(54) MULTI-PORT INVERTER/CONVERTER SYSTEM FOR DYNAMIC MICRO-GRID APPLICATIONS

(71) Applicant: DYNAPOWER COMPANY, LLC, South Burlington, VT (US)

(72) Inventors: Kyle B. Clark, Underhill, VT (US); Leonard E. Lansing, Mississauga (CA)

(73) Assignee: DYNAPOWER COMPANY, LLC, South Burlington, VT (US)

(21) Appl. No.: 13/890,948

(22) Filed: May 9, 2013

Related U.S. Application Data
(60) Provisional application No. 61/644,547, filed on May 9, 2012.

(51) Int. Cl. H02J 4/00

(52) U.S. Cl. CPC H02J 4/00
USPC 307/26; 307/82

(57) ABSTRACT

The present invention provides a novel electrical power system for micro-grid and distributed generation systems. The invention provides a common, singular Alternating Current (AC) electrical port for multiple Direct Current (DC) generation sources, DC loads and DC electrical energy storage sources. The invention balances the flow of energy through said storage, load and generation sources to provide a constant voltage and frequency to a micro-grid or a regulated real and reactive power component to an electric utility grid. A centralized controller is capable of commanding bi-directional current flow on each DC port in order to maintain an optimum State of Charge such that the storage medium can service both the utility grid and a micro-grid and dynamically transfer between the two operational modes.

### CROSS-REFERENCE TO RELATED APPLICATION

This application claims the priority benefit of U.S. Provisional Patent Application No. 61/644,547 entitled “MULTI-PORT INVERTER/CONVERTER SYSTEM FOR DYNAMIC MICRO-GRID APPLICATIONS,” filed on May 9, 2012, by Kyle Clark et al., the entire disclosure of which is incorporated herein by reference.

### BACKGROUND OF THE INVENTION

The present invention is directed to electrical power micro-grids and distributed generation systems ranging in size from several kilowatts to many megawatts where a plurality of generation, electrical storage and loads are interconnected to support, control and balance the flow of electrical power and energy.

Current micro-grid systems provide connection of loads, generation and storage at a common or multiple Alternating Current (AC) ports. This arrangement of AC coupled systems provides unnecessary electrical conversion losses, potential for multiple resonant frequencies, system instability and installation and control complexity. Current systems are generally not capable of seamless dynamic transfer from a utility (Grid-Tied) mode where real and reactive power are provided to the larger grid to a Micro-Grid mode where voltage and frequency is maintained by a singular or multiple coordinated sources.

### SUMMARY OF THE INVENTION

According to an embodiment of the present invention, an electrical power inverter/converter system is provided comprising a plurality of DC ports coupled to DC sources; a common AC port connected to a utility grid; a plurality of DC/DC converters each coupled to a respective one of the DC ports; an inverter coupled between the DC/DC converter and the common AC port; and a controller for monitoring the utility grid and voltage levels of the DC sources, the controller coupled to the DC/DC converters for balancing the current flow between the DC ports and the common AC port to maintain a constant AC voltage and frequency to service electrical loads.

According to another embodiment of the present invention, an electrical power inverter/converter system is provided comprising a plurality of DC electrical ports; an AC port capable producing bi-directional AC current when connected to an electric utility grid; a plurality of DC/DC converters each coupled to a respective one of the DC ports; and a controller for disconnecting the system at the AC port from the utility grid and switching modes by controlling the DC/DC converters to provide a fixed voltage and frequency for a micro-grid.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is an electrical schematic diagram depicting the current state of the art wherein the generation and storage mediums are connected at the AC ports; and

FIG. 2 is an electrical schematic diagram depicting a single implementation of the multi-port inverter/converter system of the present invention where the generation and storage mediums are connected at a DC port and an AC port is provided for connection to a utility service and/or a micro-grid.

### DETAILED DESCRIPTION OF THE EMBODIMENTS

Reference will now be made in detail to the present preferred embodiments of the invention, examples of which are illustrated in the accompanying drawings. Wherever possible, the same reference numerals will be used throughout the drawings to refer to the same or like parts.

The present invention regulates and controls the flow of electrical current into a micro-grid or utility grid that services electrical loads. Generally static generation and storage devices produce Direct Current (DC) which must be converted to Alternating Current (AC) prior to becoming useful for standard AC utility loads.

The present invention provides a common AC port for multiple DC generation, storage sources and loads and balances the flow of energy through said storage, loads and generation sources to provide a constant voltage and frequency to the micro-grid or a coordinated real and reactive power component to a utility connection and means for dynamically transferring between Grid-Tied and Micro-Grid operation without interruption of the electrical service.

One embodiment of the present invention includes Battery Energy Storage, a Fuel Cell Generator, and Photovoltaic Generation connected through integrated independently controlled DC/DC converters that provide a voltage source to an AC/DC power inverter. In the first mode, the inverter controls the real and reactive current to the grid to maintain a desired voltage and frequency. The flow of energy through each DC/DC converter is modulated to maintain an appropriate voltage source to the inverter. The system is regulated by a centralized controller capable of commanding bi-directional current flow to and from the batteries and curtailing both the fuel cell and photovoltaic sources. In the second mode of operation, the same inverter provides an AC voltage source to a micro-grid and the DC current becomes the independent variable. Switching between the modes is done seamlessly without interruption to the AC electrical service.

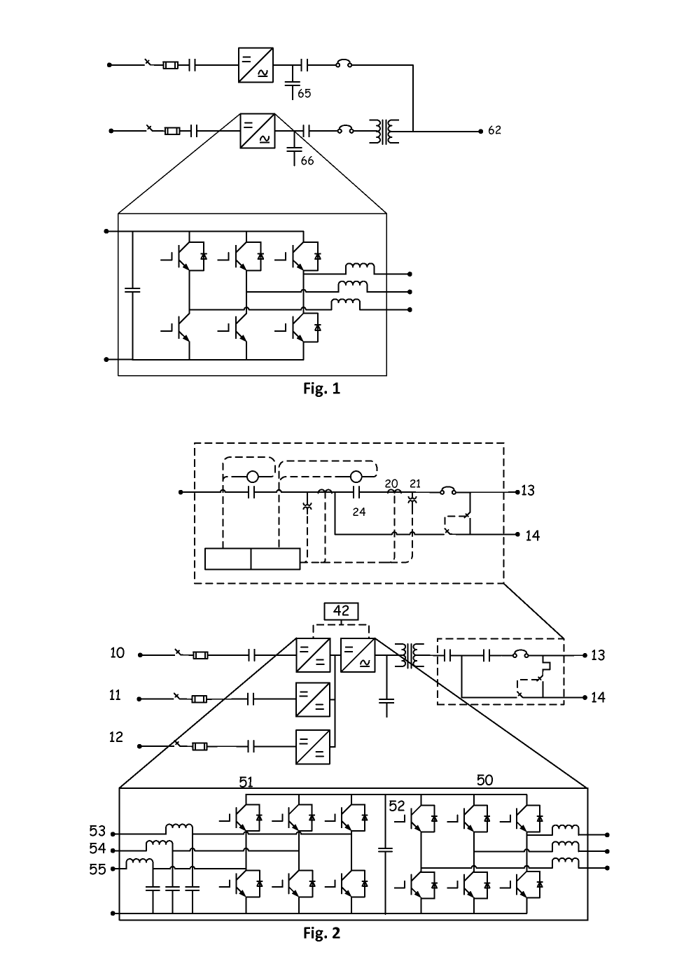

Renewable energy such as wind generation and photovoltaic generators are volatile and subject to unpredictable and inconvenient weather patterns. The generation source rarely matches the load needs; therefore it is desirable to provide some means of storage to buffer the flow of power between the generation source and the grid. Traditionally, as shown in FIG. 1, these generation and storage mediums were connected at the AC port (62) of inverter/converters and a separate, centralized controller would curtail loads and control the battery inverter/converter to absorb or supply surplus and required power respectively. Unnecessary conversion to AC power is both inefficient and requires system-level design to preclude dangerous resonant oscillations between multiple solid-state and rotational AC system filters (65 and 66).

As shown in FIG. 2, the present invention provides DC/DC converter modules tied to each generation or storage source (10, 11 and 12) and a controller (42) regulates the flow of DC current to the intermediate DC voltage source supplying the inverter to the grid. The single inverter is then responsible for regulating AC current, both real and reactive, to maintain a fixed frequency and voltage.

In the case of multi-port systems including photovoltaic systems, a power point tracking algorithm in the present invention has the capability to curtail the power from the photovoltaic (PV) cells to maintain an optimum state of charge of the batteries and/or to maximize the efficiency of the system.

Solid state inverter systems are known in the industry capable of both Grid-Tied (current control) and Stand-Alone (voltage and frequency control) operation. The present invention provides means to transfer dynamically and seamlessly between the two operational modes at the the single AC port eliminating the coordination of multiple sources during the transfer. This transfer operation works by monitoring the utility grid with current and voltage transducers (20 and 21) and disconnecting by an islanding contactor (24) and regulating the flow of current during the transfer to the load port (14). When the utility grid connected at the AC port (13) is sensed via a potential transformer (21) to be within a predetermined range for example; Grid Voltage ≧0.88 Per Unit Voltage (PU) and <1.10 PU and Grid Frequency ≧59.8 Hz and ≦60.5 Hz, the output frequency of AC/DC converter controller (42) slews to match the utility grid prior to closing contactor (24) and transitioning to a current controlled mode.

Having described the general principles of the present invention, an example of one embodiment thereof is described below.

In one operational mode (Grid-Tied) where the utility grid at (13) requires a specific power supplied by the multi-port inverter/converter system, grid output power P_{I} is provided by both solar power P_{PV} and batteries P_{B}. In this mode, the system is given a single power command at the AC Port (13). The power will come from the PV cells with the battery power being provided as a buffer. Ignoring losses in the conversion, the battery power (P_{B}) will be varied by its associated DC/DC converter to keep the grid AC Port (P_{I}) at the specified power (P_{B}=P_{I}−P_{PV}). However if P_{PV}>P_{I} then the excess power will be used to charge the batteries. If the batteries are at their maximum State of Charge and P_{PV}>P_{I} then P_{PV} will be curtailed by modulating the voltage on the solar input to reduce power such that P_{PV}=P_{I}. Where:
P_{PV}=Photovoltaic Power
P_{I}=AC Grid Power
P_{B}=Battery Power

In a second operational mode (micro-grid) where the multi-port inverter/converter system objective is to maintain AC voltage and frequency and is provided both solar power and batteries the system coordinates the flow of power in and out of the batteries. The power will come from the PV independently with the battery power being provided as a buffer. Ignoring losses in the conversion, the battery power (P_{B}) will be varied to keep the grid AC Port at the specified voltage V_{AC}=P_{I}/I_{AC} and P_{B}=P_{I}−P_{PV}. In the case that the P_{PV} exceeds the P_{I} and the batteries are at their maximum State of Charge P_{PV} will be curtailed by modulating the voltage on the solar input to reduce power such that P_{PV}=P_{I}. Where:
V_{AC}=AC Voltage
I_{AC} =AC Current

In one application the DC/DC converter section (51) and the AC/DC conversation system (50) are comprised of Insulated Gate Bi-Polar Transistors (IGBTS) with anti-parallel diodes. Each pair of series connected IGBTs is capable of operating in either a buck mode in the case where current flows from the DC link (52) to the DC ports (53, 54 and 55) in a boost mode where the current flows from the DC ports (53, 54 and 55) to the intermediate DC voltage link (52).

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An electrical power inverter/converter system comprising:
a plurality of DC ports coupled to DC sources;
a common AC port connected to a utility grid;
a plurality of DC/DC converters each coupled to a respective one of said DC ports;
an inverter coupled between said DC/DC converter and said common AC port; and
a controller for monitoring the utility grid and voltage levels of said DC sources, said controller coupled to said DC/DC converters for balancing the current flow between said DC ports and said common AC port to maintain a constant AC voltage and frequency to service electrical loads.

2. The system of claim 1, wherein said inverter is a solid-state inverter.

3. The system of claim 2, wherein said solid-state inverter and said DC/DC converters comprise switching devices having insulated gate bi-polar transistors.

4. An electrical power inverter/converter system comprising:
a plurality of DC electrical ports;
an AC port capable producing bi-directional AC current when connected to an electric utility grid;
a plurality of DC/DC converters each coupled to a respective one of said DC ports; and
a controller for disconnecting the system at the AC port from the utility grid and switching modes by controlling said DC/DC converters to provide a fixed voltage and frequency for a micro-grid.
